(19) United States
(12) Patent Application Publication
(10) Pub. No.: US 2019/0143470 A1
(43) Pub. Date: May 16, 2019

(54) SERVO TUNING DEVICE AND SERVO TUNING METHOD

(71) Applicant: INDUSTRIAL TECHNOLOGY RESEARCH INSTITUTE, Hsinchu (TW)

(72) Inventors: Wei-Sheng CHEN, Changhua County (TW); Shih-Chang LIANG, Changhua City (TW); Po-Hsun WU, Taichung City (TW); Yu-Sheng ZENG, Taichung City (TW); Tsung-Yu YANG, Taichung City (TW)

(73) Assignee: INDUSTRIAL TECHNOLOGY RESEARCH INSTITUTE, Hsinchu (TW)

(21) Appl. No.: 15/851,271

(22) Filed: Dec. 21, 2017

(30) Foreign Application Priority Data
Nov. 10, 2017 (TW) 106139018

(51) Int. Cl. B23Q 17/24; B23B 25/06; B23Q 15/22; G01B 11/27

(52) U.S. Cl. CPC B23Q 17/2414; B23B 25/06; B23Q 17/2452; G01B 11/272; B23Q 15/22

(57) ABSTRACT

A servo tuning device adapted to a multi-axis machine tool at least having two linear axes and a rotation axis used for a moving base and a working platform to move relatively along the two linear axes and the rotation axis. The servo tuning device includes a reflection component, a photoelectric sensor and a processor. The reflection component is configured to be disposed on one of the moving base and the working platform and has a reflection surface. The photoelectric sensor has a light-emitting element and a light-receiving element facing the reflection surface. The photoelectric sensor is configured to be disposed on the other one of the moving base and the working platform. The processor records information of relative movement between the photoelectric sensor and the reflection surface for calculating a loop gain value used for tuning a servo setting of the two linear axes or the rotation axis.

### CROSS-REFERENCE TO RELATED APPLICATIONS

This non-provisional application claims priority under 35 U.S.C. § 119(a) on Patent Application No(s). 106139018 filed in Taiwan, R.O.C. on Nov. 10, 2017, the entire contents of which are hereby incorporated by reference.

### TECHNICAL FIELD

The disclosure relates to a servo tuning device and a servo tuning method.

### BACKGROUND

For the servo matching of a conventional three-axis machine tool, the servo loop gain is generally tuned using the circular test, so that the servo of three axes of the machine tool is matched. Currently, in order to verify and reach a servo matching status of five-axes of a five-axis machine tool, a general approach is to tune the servo gains of the three linear axes through the Double Ball Bar (DBB) while the two rotating axes are tuned to be in a best condition based on experiences provided by factories. The verification method is to perform R-Test to measure K1/K2/K4 dynamic error, or directly perform a cutting validation for the work piece, such as turbine blades, NAS979 and so on. However, the aforementioned verification method is not capable of indicating which axis servo mismatches causes the dynamic error of the five-axis machine, and the verification process is complicated and lengthy.

In addition, with the popularization of five-axis machine tools, it is inevitable that the servo motors of a five-axis machine tool are not specifically and originally designed of said five-axis machine tool. In a servo system with these kinds of servo motors, there is usually no report generated for verifying the tuning of the servo gains of two rotating axes of the five-axis machine tool even though reports can be generated by instruments to prove the servo matching accuracy of three linear axes. Furthermore, there are structural factors exist between the servo end and the machined work piece. These potential structural factors directly affect the quality of the work piece, but problems can not be analyzed or verified through instruments or equipment. Therefore, in the field of multi-axis machine tools, verifying the servo setting of the rotating axes so as to match with the linear axes is an important issue.

### SUMMARY

A servo tuning device is disclosed according to one embodiment of the present disclosure. The servo tuning device is adapted to a multi-axis machine tool at least having two linear axes and a rotation axis, with the two linear axes and the rotation axis configured to allow a moving base and a working platform of the multi-axis machine tool to move relatively to each other. The servo tuning device comprises a reflection component, a photoelectric sensor and a processor. The reflection component is configured to be disposed on one of the moving base and the working platform and has a reflection surface. The photoelectric sensor has a light-emitting element and a light-receiving element, with both of the light-emitting element and the light-receiving element facing the reflection surface of the reflection component. The photoelectric sensor is configured to be disposed on the other one of the moving base and the working platform. The processor is electrically connected to the photoelectric sensor and records information of relative movement between the photoelectric sensor and the reflection surface so as to calculate a loop gain value for tuning a servo setting of the two linear axes or the rotation axis.

A servo tuning method is disclosed according to one embodiment of the present disclosure. The servo tuning method is adapted to a multi-axis machine tool at least having two linear axes and a rotation axis configured to allow a moving base and a working platform of the multi-axis machine tool to move relatively to each other. The servo tuning method comprises the following steps: disposing a reflection component on one of the moving base and the working platform and disposing a photoelectric sensor on the other one of the moving base and the working platform; actuating the moving base and the working platform so that a light image, emitted by the photoelectric sensor, moves along a path on a reflection surface of the reflection component; and calculating a loop gain value according to information of relative movement between the photoelectric sensor and the reflection surface for tuning a servo setting of the two linear axes or the rotation axis.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a stereoscopic view of a servo tuning device and a multi-axis machine tool;

FIG. 2A and FIG. 2B are diagrams of measurement regarding a relative movement between an reflection component and a photoelectric sensor on a first path according to one embodiment of the present disclosure;

FIG. 3 is a diagram of forward/backward displacement variation according to one embodiment of the present disclosure;

FIG. 4A and FIG. 4B are diagrams of measurement regarding a relative movement between the reflection component and the photoelectric sensor on the first path according to another embodiment of the present disclosure;

FIG. 5 is diagram of forward/backward displacement variation according to another embodiment of the present disclosure;

FIG. 6 is a stereoscopic view of a servo tuning device and a multi-axis machine tool according to another embodiment of the present disclosure;

FIG. 7A and FIG. 7B are diagrams of measurement regarding a relative movement between the reflection component and the photoelectric sensor on a second path according to one embodiment of the present disclosure;

FIG. 8 is a diagram of forward/backward displacement variation according to one embodiment of the present disclosure;

FIG. 9A and FIG. 9B are diagrams of measurement regarding a relative movement between the reflection component and the photoelectric sensor on the second path according to another embodiment of the present disclosure;

FIG. 10 is diagram of forward/backward displacement variation according to another embodiment of the present disclosure;

FIG. 11 is a diagram of a regression analysis according to one embodiment of the present disclosure;

FIG. 12 to FIG. 15 are respectively stereoscopic views of a servo tuning device and a multi-axis machine tool according to embodiments of the present disclosure;

FIG. 16 is a diagram of flow chart illustrating a servo tuning method according to one embodiment of the present disclosure; and

FIG. 17 is a diagram of flow chart illustrating a servo tuning method according to another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

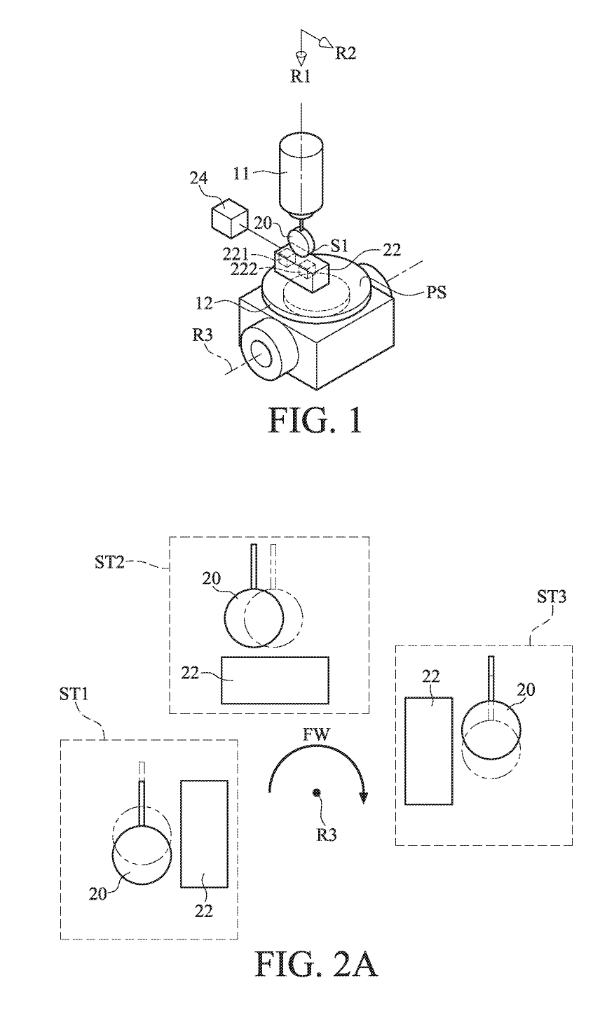

Please refer to FIG. 1, which is a stereoscopic view of a servo tuning device and a multi-axis machine tool according to one embodiment of the present disclosure. As shown in FIG. 1, the multi-axis machine tool has two linear axes R1 and R2 as well as a rotation axis R3, with the two linear axes R1 and R2 as well as the rotation axis R3 configured to allow a moving base 11 and a working platform 12 of the multi-axis machine tool move relatively to each other respectively along the two linear axes R1 and R2 as well as about the rotation axis R3. The servo tuning device adapted to the multi-axis machine tool includes a reflection component 20, a photoelectric sensor 22 and a processor 24. The reflection component 20 is disposed on the moving base 11 and the photoelectric sensor 22 is disposed on the working platform 12 before performing a servo tuning to the multi-axis machine tool. The reflection component 20 has a reflection surface S1, and the photoelectric sensor 22 has a light-emitting element 221 and a light-receiving element 222, with both of the light-emitting element 221 and the light-receiving element 222 facing the reflection surface S1 of the reflection component 20. The processor 24 is electrically connected to the photoelectric sensor 22 and configured to record information of relative movement between the photoelectric sensor 22 and the reflection surface S1 in order to calculate a loop gain value for tuning the servo setting of the two linear axes R1 and R2 or the servo setting of the rotation axis R3. The servo setting, for example, includes a speed of displacement. However, the present disclosure is not limited to this example.

In one embodiment, the information of relative movement between the photoelectric sensor 22 and the reflection surface S1 includes a set of tracking error values generated by a movement of a light image along a path on the reflection surface S1, and the light image is emitted onto the reflection surface S1 by the photoelectric sensor 22. In practice, a set of forward/backward displacements related to a light image is generated while the light image moves forward/backward along the path, with the set of forward/backward displacements including a forward displacement generated while the light image moves forwards along the path and a backward displacement generated while the light image moves backward along the path. Thereafter, the processor obtains the set of tracking error values by processing the set of forward/backward displacements. Particularly, said forward displacement shows a relative movement between the photoelectric sensor 22 and the reflection surface S1 during a period wherein the light image moves forwards in the path, and a forward total relative movement is defined as an integral value of a variation of the relative movement. Similarly, said backward displacement shows another relative movement between the photoelectric sensor 22 and the reflection surface S1 during another period wherein the light image moves backwards in the path, and a backward total relative movement is defined as an integral value of a variation of the another relative movement. Namely, the forward total relative movement is formed during the period wherein the light image moves forward along the path, and said backward total relative movement is formed during said another period wherein the light image moves backward along the path. More specifically, the tracking error values are related to a difference between the forward total relative movement of the photoelectric sensor 22 to the reflection surface S1 and the backward total relative movement of the photoelectric sensor 22 to the reflection surface S1. In practice, the path is an ISO K1/K2 path or a TCP/TCPM path.

In this embodiment, the photoelectric sensor 22 and the reflection component 20 move along routes in the process of testing the matching status of two linear axes R1 and R2 as well as about the rotation axis R3. When the photoelectric sensor 22 and the reflection component 20 move along the routes, the photoelectric sensor 22 emits a signal of a light image through the light-emitting element 221 to the reflection surface S1, and receives another signal of the light image through the light-receiving element 222, with the another signal of the light image is reflected by the reflection surface S1. If a servo mismatch exists between the linear axes and the rotation axis of the multi-axis machine tool, the photoelectric sensor 22 obtains the set of forward/backward displacements generated as the light image moves along the path forwards and backwards. The processor 24 calculates a set of tracking error values based on the set of forward/backward displacements. The processor 24 calculates an ideal loop gain value by analyzing a plurality of tracking error values, so as to tune the servo setting of two linear axes R1 and R2 or the servo setting of the rotation axis R3 for achieving a servo matching status.

In further, in one embodiment, the set of tracking error values includes a first tracking error value and a second tracking error values. The first tracking error value is generated corresponding to a first loop gain applied to the routes, and the second tracking error value is generated corresponding to a second loop gain applied to the routes. In other words, in the process of testing the servo matching status between the two linear axes R1 and R2 and the rotation axis R3, the moving base 11 and the working platform 12 are actuated according to a loop gain applied, so that a first set of forward/backward displacements is generated by the forward and backward movements of the reflection component 20 and the photoelectric sensor 22 along the routes respectively. Accordingly, a first tracking error values is obtained. Then, the moving base 11 and the working platform 12 are actuated according to another loop gain applied, so that a second set of forward/backward displacements is generated by the forward and backward movements of the reflection component 20 and the photoelectric sensor 22 along the routes respectively Accordingly, a second tracking error values is obtained. In practice, the various loop gains are a setting value of servo gain corresponding to the actuation for the moving base 11 and the working platform 12, and the setting value of servo gain may be a servo position loop gain value, a speed loop gain value, or a speed integrated time constant.

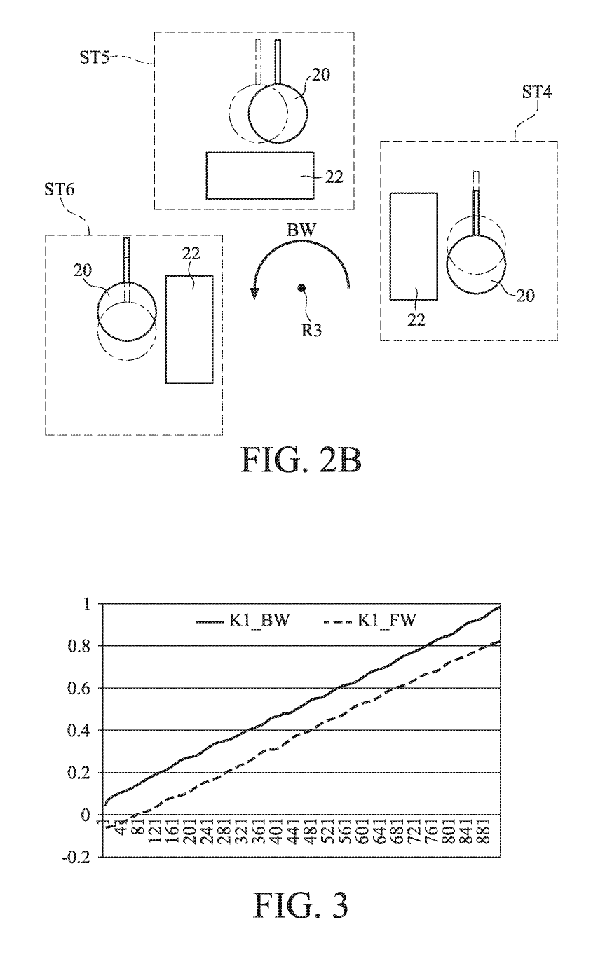

In the following paragraph, a specific example is given for illustration. A process of testing the matching status of the two linear axes R1 and R2 and the rotation axis R3 begins after the servo tuning device and the multi-axis machine tool shown in FIG. 1 are prepared. Please further refer to FIG. 2A and FIG. 2B, which are diagrams of measurement regarding a relative movement between the reflection component and the photoelectric sensor on a first path according to one embodiment of the present disclosure. When the process of testing begins, first of all, the photoelectric sensor 22 and the reflection component 20 sequentially move from the positions of status ST1 to the positions of status ST3 through the positions of status ST2 based on forward routes FW as shown in FIG. 2A. More specifically, in the process of movement from the positions of status ST1 to the positions of status ST3, a first loop gain is applied to the multi-axis machine tool to actuate the working platform 12 to rotate around the rotation axis R3 so that the photoelectric sensor 22 moves accordingly, and actuate the moving base 11 to move in the direction of the sum of movement vectors of the two linear axes R1 and R2 so that the reflection component 20 moves accordingly. After the process of sequential movement from the positions of status ST1 to the positions of status ST3 is completed, the photoelectric sensor 22 and the reflection component 20 move from the positions of status ST4 to the positions of status ST6 through the positions of status ST5 based on backward routes BW, as shown in FIG. 2B.

In this embodiment, as shown in FIG. 1, the rotation axis R3 is parallel to a supporting surface PS of the working platform 12. One of the two linear axes, the linear axis R1, is parallel to the supporting surface PS and the other of the two linear axes, the linear axis R2, is perpendicular to the supporting surface PS. Specifically, in the process of movement from the positions of status ST4 to the positions of status ST6, the first loop gain is applied to actuate the working platform 12 to rotate around the rotation axis R3 so as to drive the photoelectric sensor 22 to move, and to actuate the moving base 11 to move in a direction of the sum of movement vectors of the two linear axes R1 and R2 so as to drive the reflection component 20 to move. The direction of the sum of movement vectors of the two linear axes R1 and R2 in this embodiment is different from the direction of the sum of movement vectors of the two linear axes R1 and R2 in the aforementioned embodiment in which the movement is performed from the positions of status ST1 to the positions of status ST3. In one embodiment, the reflection surface S1 of the reflection component 20 is an arc surface so that the distance between the photoelectric sensor 22 and the reflection surface S1 of the reflection component 20 approximately remains consistent when they move in the routes for the light image to move in a forward/backward path as the first path, so as to complete the measurement.

If a servo mismatch exists between the two linear axes R1 and R2 and the rotation axis R3 of the multi-axis machine tool, a first tracking error value is generated as the light image emitted onto the reflection component 20 by the photoelectric sensor 22 and moves along the forward/backward path in the process of proceeding a movement along the forward/backward path. More specifically, as shown in FIG. 2A and FIG. 2B, in the process of the sequential movement from the positions of status ST1 to the positions of status ST3 as well as the sequential movement from the positions of status ST4 to the positions of status ST6, the actual position (shown by solid line) of the reflection component 20 moving with the two linear axes R1 and R2 is behind the predetermined position (shown by dotted line) of the reflection component 20, with the predetermined position (shown by dotted line) aligned with the photoelectric sensor 22 moving with the rotation axis R3. In other words, the servo of rotation axis R3 is behind the servo of the two linear axes R1 and R2. In this embodiment, the first tracking error values is considered as a position error between the actual position (shown by solid line) of the reflection component 20 and the predetermined position (shown by dotted line) of the reflection component 20.

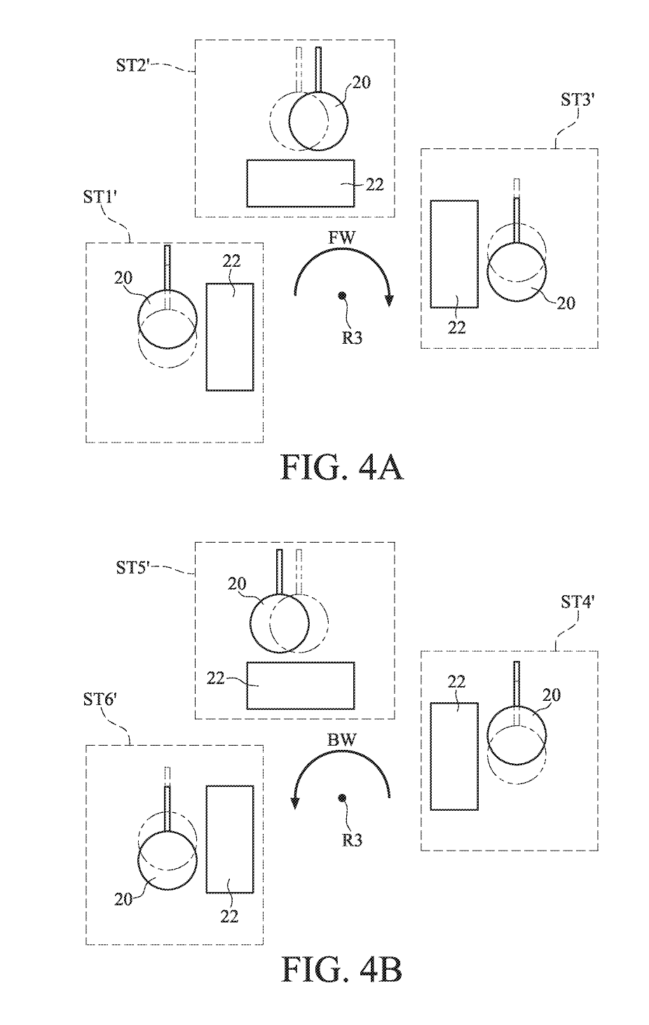

Please further refer to FIG. 3, which is a diagram of forward/backward displacements variation according to one embodiment of the present disclosure. When the photoelectric sensor 22 senses the displacement information (the information of relative movements between the photoelectric sensor and the reflection surface) corresponding to the forward/backward path by emitting and receiving the light image, the processor 24 generates a diagram based on the displacement information, as shown in FIG. 3. FIG. 2A, FIG. 2B and FIG. 3 are embodiments illustrating a condition in which the servo of the rotation axis R3 is ahead of the servo of the two linear axes R1 and R2. Contrarily, in another condition, the servo of the two linear axes R1 and R2 is ahead of the servo of the rotation axis R3. Please refer to FIG. 4A and FIG. 4B, which are diagrams of measurement regarding a relative movement between the reflection component and the photoelectric sensor on the first path according to another embodiment of the present disclosure. Similarly, as shown in FIG. 4A, the photoelectric sensor 22 and the reflection component 20 sequentially move from the positions of status ST1′ to the positions of status ST3′ through the positions of status ST2′ based on forward routes FW. As shown in FIG. 4B, the photoelectric sensor 22 and the reflection component 20 then sequentially move from the positions of status ST4′ to the positions of status ST6′ passing through the positions of status ST5′ based on backward routes BW.

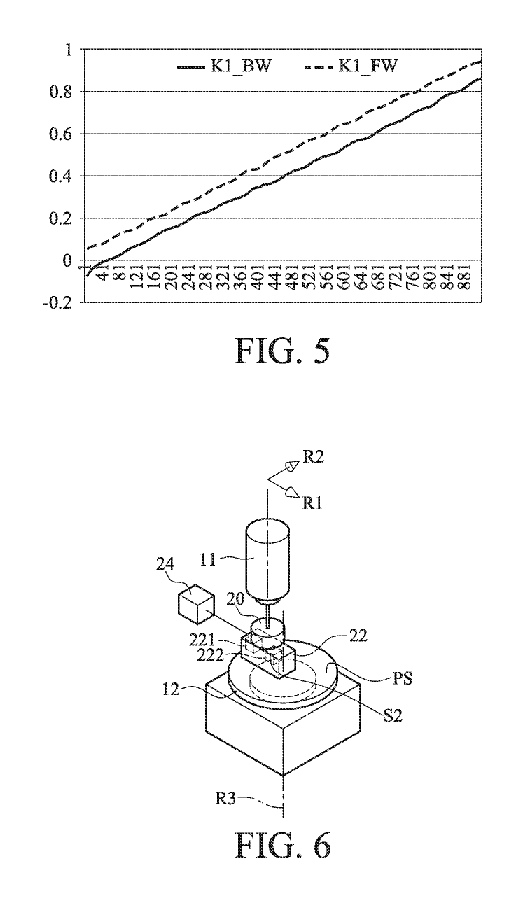

In this embodiment, a second loop gain is applied to the multi-axis machine tool so as to actuate the working platform 12 to rotate around the rotation axis R3 and actuate the moving base 11 moves in the direction of the sum of movement vectors of two linear axes R1 and R2. Accordingly, the photoelectric sensor 22 and the reflection component 20 move so that the measurement corresponding to the forward/backward path is completed. Regarding the rotation around the rotation axis R3 and the sum of movement vectors of two linear axes R1 and R2 mentioned in FIG. 4A and FIG. 4B are similar to that in FIG. 2A and FIG. 2B, so not repeated here. The difference between the embodiment of FIG. 4A-4B and the embodiment of FIG. 2A-2B is that the actual position (shown by solid line) of the reflection component 20 moving with the two linear axes R1 and R2 is ahead of the predetermined position (shown by dotted line) of the reflection component 20, with the predetermined position (shown by dotted line) aligned with the photoelectric sensor 22 moving with the rotation axis R3. In other words, the servo of the rotation axis R3 is behind of the servo of the two linear axes R1 and R2. Please further refer to FIG. 5, which is a diagram of forward/backward displacement variation according to another embodiment of the present disclosure. Similarly, when the photoelectric sensor 22 senses the displacement information (the information of relative movements between the photoelectric sensor and the reflection surface) corresponding to the forward/backward path, that is, the first path by emitting and receiving the light image, the processor 24 generates a diagram based on the displacement information, as shown in FIG. 5.

The processor 24 obtains the forward total relative movement of the photoelectric sensor 22 to the reflection surface S1 and the backward total relative movement of the photoelectric sensor 22 to the reflection surface S1 by respectively accumulating the amount of forward displacement variation and the amount of backward displacement variation. The difference between the forward total relative movement of the photoelectric sensor 22 to the reflection surface S1 and a backward total relative movement of the photoelectric sensor 22 to the reflection surface S1 is related to the tracking errors value corresponding to the forward/backward path calculated by the processor 24.

In practice, different loop gains may be applied to the multi-axis machine tool so as to actuate the working platform 12 to rotate around the rotation axis R3 and actuate the moving base 11 to move in the direction of the sum of movement vectors of the two linear axes R1 and R2, so that the photoelectric sensor 22 and the reflection component 20 move accordingly. Therefore, the processor 24 obtains a plurality of tracking error values and further determines an ideal loop gain value using a regression analysis according those tracking error values and loop gains applied. Then, the processor 24 tunes the servo setting of the two linear axes or the servo setting of the rotation axis based on the ideal loop gain value, so that the two linear axes and the rotation axis reach a matching status, which means the tracking error of the multi-axis machine tool is minimized.

The measurement regarding the first path mentioned in the aforementioned embodiment is performed based on the structure of the multi-axis machine tool shown in FIG. 1. However, in other embodiment, the structure of multi-axis machine tool is modified to perform a measurement of a second path different from the first path. Please refer to FIG. 6, which is a stereoscopic view of a servo tuning device and a multi-axis machine tool according to another embodiment of the present disclosure. Similar to the embodiment of FIG. 1, the multi-axis machine tool shown in FIG. 6 has the two linear axes R1 and R2 and the rotation axis R3 configured to allow the moving base 11 and the working platform 12 of the multi-axis machine tool move relatively to each other along the two linear axes R1 and R2 and rotate about the rotation axis R3. Different from the embodiment of FIG. 1, in the multi-axis machine tool of FIG. 6, the rotation axis R3 is perpendicular to the supporting surface PS of the working platform 12, and the two linear axes R1 and R2 are parallel to the supporting surface PS. The working platform 12 and the moving base 11 move along the second path serving as the measurement path, with the second path is formed by a rotation around the rotation axis R3 as well as a sum of movement vectors of the two linear axes.

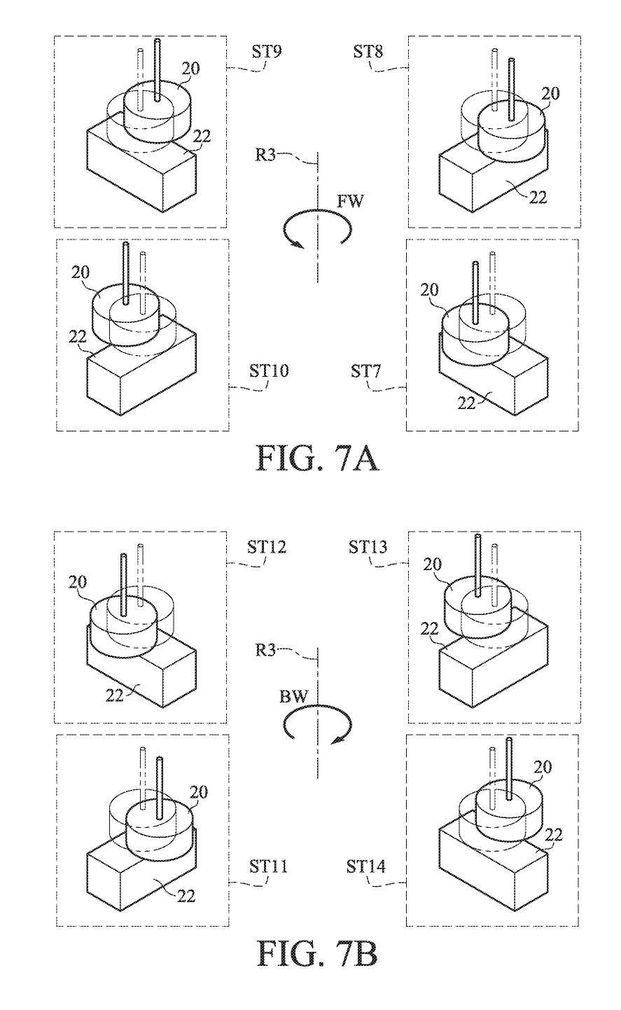

More specifically, please further refer to FIG. 7A and FIG. 7B, which are diagrams of measurement regarding a relative movement between the reflection component and the photoelectric sensor on a second path according to one embodiment of the present disclosure. When the test starts, the photoelectric sensor 22 and the reflection component 20 move from the positions of status ST7 to the positions of status ST10 through the positions of status ST8 and ST9 sequentially based on forward routes FW. In other words, in the process of sequential movement from the positions of status ST7 to the positions of status ST9, the first loop gain is applied to the multi-axis machine tool to actuate the working platform 12 to rotate about the rotation axis R3 so that the photoelectric sensor 22 moves accordingly, and to actuate the moving base 11 to move in the direction of the sum of movement vectors of the two linear axes R1 and R2 so that the reflection component 20 moves accordingly. After the movement from the positions of status ST7 to the positions of status ST9 is completed, the photoelectric sensor 22 and the reflection component 20 move from the positions of status ST11 to the positions of status ST14 through the positions of status ST12 and ST13 sequentially based on backward routes. In one embodiment, the reflection surface S2 of the reflection component 20 is a flat surface so that the distance between the photoelectric sensor 22 and the reflection surface S2 of the reflection component 20 remain consistent approximately when they move in the routes for the light image to move in a forward/backward path as the first path, so as to complete the measurement. It is noted that since the structure of the two linear axes R1 and R2 and the rotation axis R3 of the multi-axis machine tool shown in FIG. 1 is different from that shown in FIG. 6, a movement along a vertical surface proceeds in FIG. 2A and FIG. 2B while a movement along a horizontal surface proceeds in FIG. 7A and FIG. 7B. The reflection surface of the reflection component shown in FIG. 1 is an arc surface, and the reflection surface of the reflection component shown in FIG. 6 is a flat surface. However, in practice, the reflection surface of the reflection component is a curved surface, a flat surface, an arc surface or a tapered surface, etc.

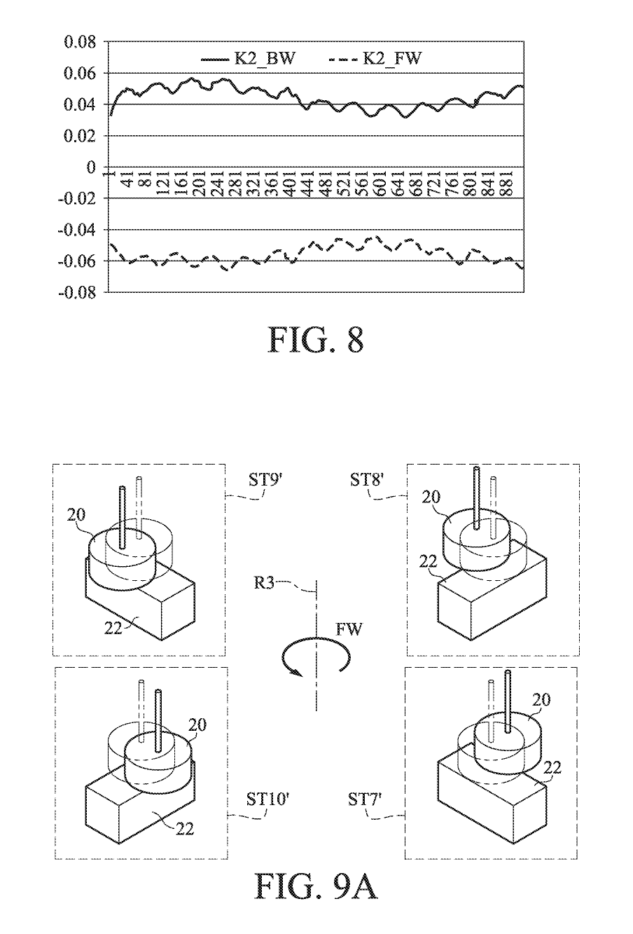

If a mismatch exists between the two linear axes R1 and R2 and the rotation axis R3 in the multi-axis machine tool in FIG. 6, then a first tracking error value is generated as the light image, emitted onto the reflection component 20 by the photoelectric sensor 22, moves along the path forwards and backwards in the process of proceeding a movement along the forward/backward path. More specifically, as shown in FIG. 7A and FIG. 7B, in the process of the sequential movement from the positions of status ST7 to the positions of status ST10 as well as the sequential movement from the positions of status ST11 to the position of status ST14, the actual position (shown by solid line) of the reflection component 20 moving with the two linear axes R1 and R2 is behind the predetermined position (shown by dotted line) of the reflection component 20, with the predetermined position (shown by dotted line) aligned with the photoelectric sensor 22 moving with the rotation axis R3. In other words, the movement of the rotation axis R3 is ahead of the movement of the two linear axes R1 and R2. In this embodiment, the first tracking error values is considered as a position error between the actual position (shown by solid line) of the reflection component 20 and the predetermined position (shown by dotted line) of the reflection component 20. Please further refer to FIG. 8, which is a diagram of forward/backward displacement variation according to one embodiment of the present disclosure. When the photoelectric sensor 22 senses the displacement information (the information of relative movement between the photoelectric sensor and the reflection surface) corresponding to the forward/backward path by emitting and receiving the light image, the processor 24 generates a diagram based on the displacement information, as shown in FIG. 8. In the diagram of displacement of this embodiment, the processor 24 obtains the forward total relative movement of the photoelectric sensor 22 to the reflection surface S1 and a backward total relative movement of the photoelectric sensor 22 to the reflection surface S1 by respectively accumulating the amount of forward displacement variation and the amount of backward displacement variation. The difference between the forward total relative movement of the photoelectric sensor 22 to the reflection surface S1 and a backward total relative movement of the photoelectric sensor 22 to the reflection surface S1 is related to the tracking errors value corresponding to the forward/backward path calculated by the processor 24.

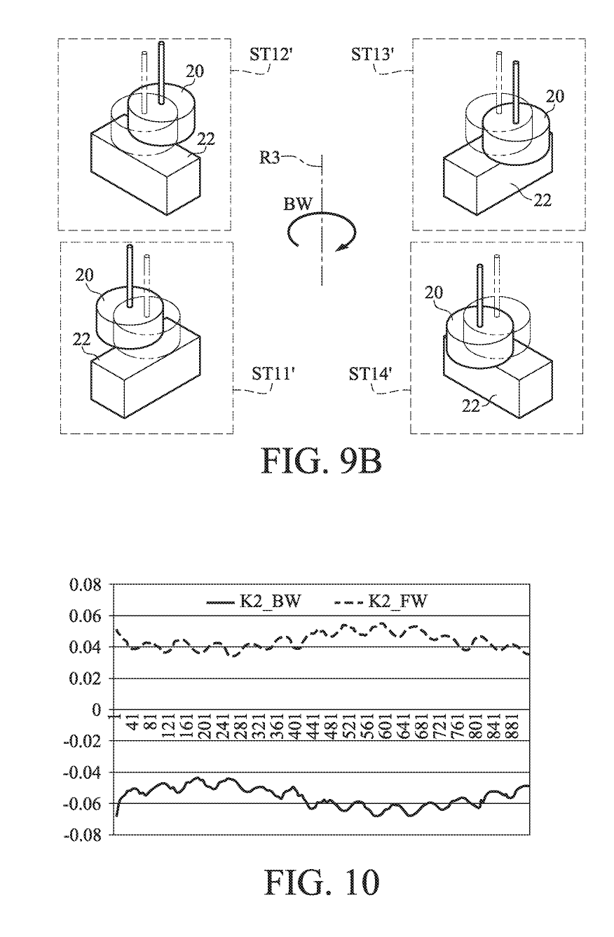

FIG. 7A, FIG. 7B and FIG. 8 are embodiments illustrating a condition in which the servo of the rotation axis R3 is ahead of servo of the two linear axes R1 and R2. Contrarily, in another condition, the servo of the two linear axes R1 and R2 is ahead of the servo of the rotation axis R3. Please refer to FIG. 9A and FIG. 9B, which are diagrams of measurement regarding a relative movement between the reflection component and the photoelectric sensor on the second path according to another embodiment of the present disclosure. Similarly, as shown in FIG. 9A, the photoelectric sensor 22 and the reflection component 20 sequentially move from the positions of status ST7′ to the positions of status ST10′ through the positions of status ST8′ and ST9′ based on forward routes FW. As shown in FIG. 9B, the photoelectric sensor 22 and the reflection component 20 then sequentially move from the positions of status ST11′ to the positions of status ST14′ through the positions of status ST12′ and ST13′ based on backward routes BW.

In this embodiment, a second loop gain is applied to the multi-axis machine tool to actuate the working platform 12 to rotate about the rotation axis R3 and to actuate the moving base 11 to move in the direction of the sum of movement vectors of the two linear axes R1 and R2. The photoelectric sensor 22 and the reflection component 20 move accordingly so that the measurement corresponding to the forward/backward path is completed. The rotation about the rotation axis R3 and the sum of movement vectors of the two linear axes R1 and R2 shown in the embodiments of FIG. 9A and FIG. 9B are similar to that shown in the embodiments of FIG. 7A and FIG. 7B, so not repeated here. The difference between the embodiment of FIG. 9A-9B and the embodiment of FIG. 7A-7B is that the actual position (shown by solid line) of the reflection component 20 moving with the two linear axes R1 and R2 is ahead of the predetermined position (shown by dotted line) of the reflection component 20, with the predetermined position (shown by dotted line) aligned with the photoelectric sensor 22 moving with the rotation axis R3. In other words, the servo of the rotation axis R3 is behind of the servo of the two linear axes R1 and R2.

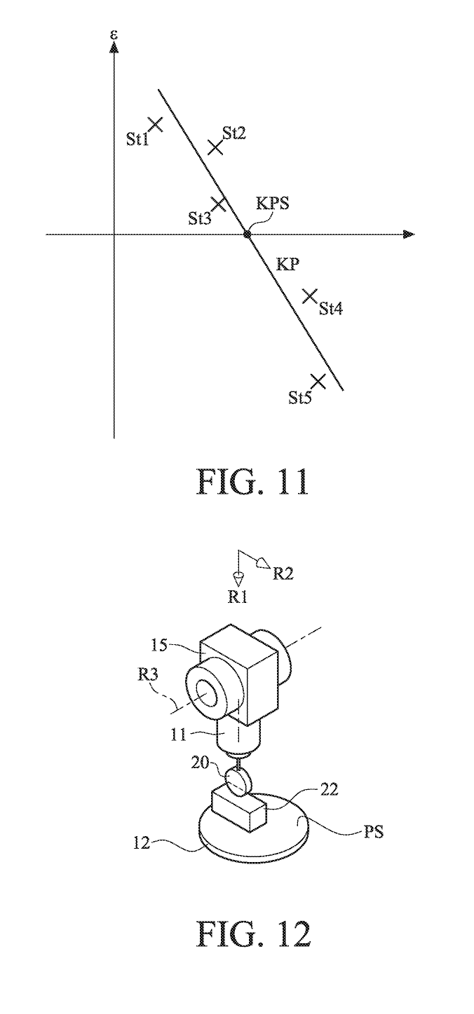

Please further refer to FIG. 10, which is diagram of forward/backward displacement variation according to another embodiment of the present disclosure. Similarly, When the photoelectric sensor 22 senses the displacement information (the information of relative movement between the photoelectric sensor and the reflection surface) corresponding to the forward/backward path by emitting and receiving the light image, the processor 24 generates a diagram based on the displacement information, as shown in FIG. 10. The processor 24 obtains the forward total relative movement of the photoelectric sensor to the reflection surface and a backward total relative movement of the photoelectric sensor to the reflection surface by respectively accumulating the amount of forward displacement variation and the amount of backward displacement variation. The difference between the forward total relative movement of the photoelectric sensor to the reflection surface and a backward total relative movement of the photoelectric sensor to the reflection surface is related to the tracking errors value corresponding to the forward/backward path calculated by the processor 24. In a practical example, after a plurality of tracking error values corresponding to different loop gains value is collected, an ideal loop gain value is obtained by a regression analysis according to the aforementioned information. For example, please refer to FIG. 11, which is a diagram of a regression analysis according to one embodiment of the present disclosure. As shown in FIG. 11, in the regression analysis, the set of tracking error values St1-St5 forms a linear trend in the diagram. The loop gain value located on the intersection of the linear trend and X axis is considered as an ideal loop gain value KPS, with the tracking error value being equal to zero in the intersection. In practice, more loop gains are applied, more accurate the linear trend is. Accordingly, a more ideal loop gain value is obtained. The engineers are able to tune the servo setting of the two linear axes R1 and R2 and/or the rotation axis R3 based on the ideal loop gain value. Therefore, the two linear axes R1 and R2 and the rotation axis R3 reach a matching status, and the machining accuracy of the multi-axis machine tool is raised accordingly.

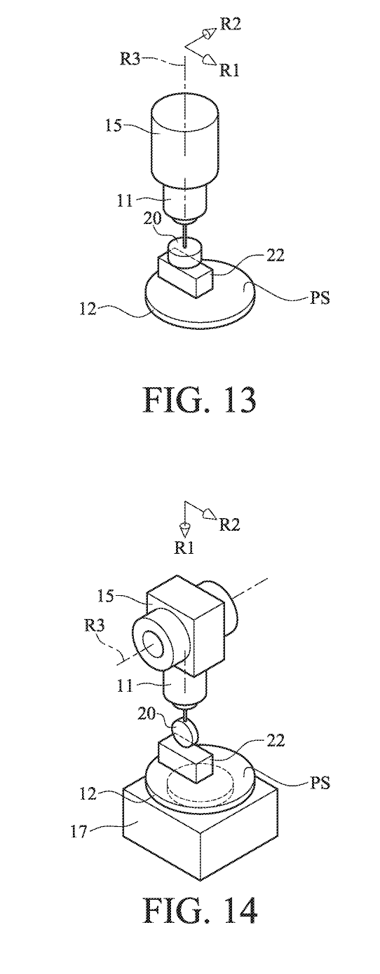

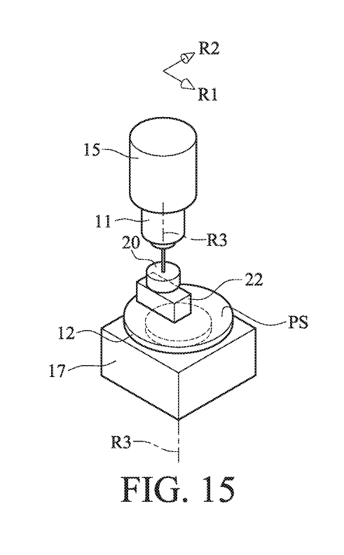

The structures of the multi-axis machine tool shown in FIG. 1 and FIG. 6 are used for illustration only. In fact, there are different structures of multi-axis machine tool configured to perform measurement based on different paths so as to match the two linear axes R1 and R2 and the rotation axis R3. Please refer to FIG. 12 to FIG. 15, which are respectively stereoscopic views of a servo tuning device and a multi-axis machine tool according to embodiments of the present disclosure. As shown in FIG. 12, the rotation axis R3 is parallel to the supporting surface PS of the working platform 12 and the spindle 15 combined with the upper part of the moving base 11 rotates about the rotation axis R3. Moreover, the spindle 15 and the moving base 11 move in the direction of the sum of movement vectors of the two linear axes R1 and R2. Accordingly, the measurements regarding the two linear axes R1 and R2 and the rotation axis R3 are performed. As shown in FIG. 13, the rotation axis R3 is perpendicular to the supporting surface PS of the working platform 12 and the spindle 15 combined with the upper part of the moving base 11 rotates about the rotation axis R3. Moreover, the spindle 15 and the moving base 11 move in the direction of the sum of movement vectors of the two linear axes R1 and R2. Accordingly, the measurements regarding the two linear axes R1 and R2 and the rotation axis R3 are performed. The servo tuning devices and the multi-axis machine tools shown in FIG. 14 and FIG. 15 are similar to that shown in FIG. 12 and FIG. 13. The difference between FIGS. 14-15 and FIGS. 12-13 is that the servo tuning devices and the multi-axis machine tools shown in FIG. 14 and FIG. 15 come with a working base 17, and further the rotation axis R3 is disposed for driving the working base 17 to move accordingly in FIG. 15.

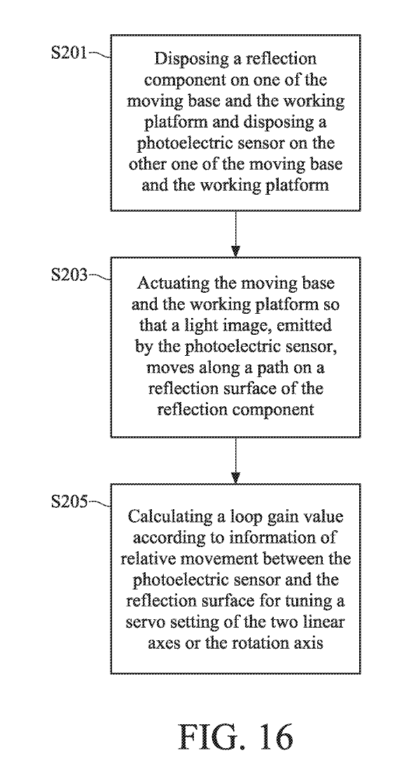

Please refer to FIG. 16, which is a diagram of flow chart illustrating a servo tuning method according to one embodiment of the present disclosure. The method is adapted to a multi-axis machine tool, such as the multi-axis machine tools of FIG. 1 and FIG. 6, which at least has two linear axes and a rotation axis configured to allow a moving base and a working platform of the multi-axis machine tool move relatively to each other along the two linear axes and the rotation axis. The servo tuning method includes steps S201-S205. In the step S201, a reflection component is disposed on one of the moving base and the working platform, and a photoelectric sensor is disposed on the other one of the moving base and the working platform by humans or mechanisms (e.g. robotic arms). Then in step S203, the processor actuates the moving base and the working platform so that a light image, emitted onto the reflection component by the photoelectric sensor, moves along a reflection surface of the reflection component. Then, in step S205, the processor calculates a loop gain value according to the information of relative movement between the photoelectric sensor and the reflection surface for tuning a servo setting of the two linear axes or a servo setting of the rotation axis. The servo setting, for example, includes a displacement speed, but the present disclosure is not limited to this example.

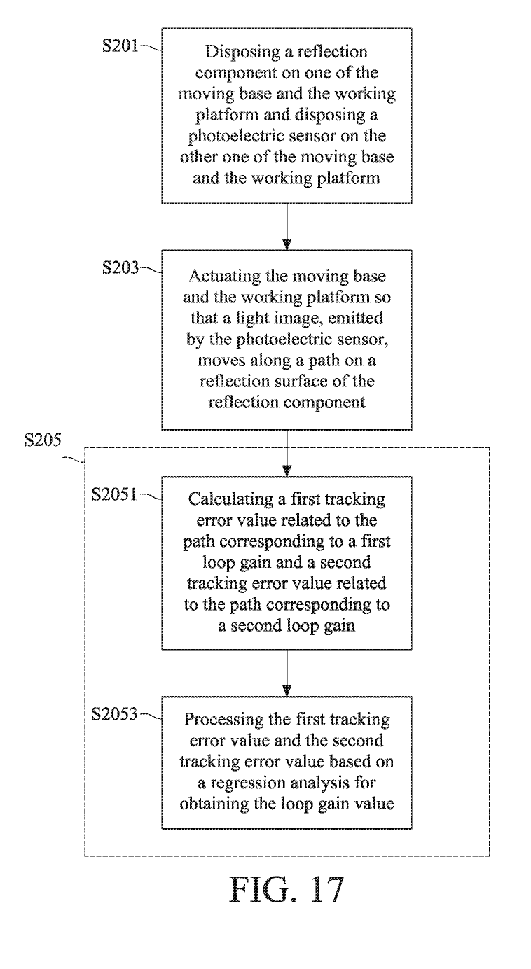

Please further refer to FIG. 17, which is a diagram of flow chart illustrating a servo tuning method according to another embodiment of the present disclosure. The method of FIG. 17 is similar to the method of FIG. 16, and the difference between them is that in FIG. 17, step S205 includes step S2051 and S2053. In step S2051, the processor calculates a first tracking error value related to the path corresponding to the first loop gain and a second tracking error value related to the path corresponding to the second loop gain. Then, in step S2053, the processor processes the first tracking error value and the tracking error value based on a regression analysis for obtaining the loop gain value. The first tracking error value and the second tracking error values are related to related to a difference between a forward total relative movement of the photoelectric sensor to the reflection surface and a backward total relative movement of the photoelectric sensor to the reflection surface, with said forward total relative movement formed during a period wherein the light image moves forward along the path, and with said backward total relative movement formed during another period wherein the light image moves backward along the path. In an example, the step of actuating the moving base and the working platform so that a light image, emitted by the photoelectric sensor, moves along a path on a reflection surface of the reflection component includes the step of actuating the working platform so that the working platform rotates about the rotation axis parallel with a supporting surface of the working platform and actuating the moving base to move in a direction of a sum of movement vectors of the two linear axes, wherein one of the two linear axes is parallel to the supporting surface and the other one of the two linear axes is perpendicular to the supporting surface. In another example, the step of actuating the moving base and the working platform so that a light image, emitted by the photoelectric sensor, moves along a path on a reflection surface of the reflection component includes the step of actuating the working platform so that the working platform rotates about the rotation axis perpendicular to a supporting surface of the working platform and actuating the moving base to move in a direction of a sum of movement vectors of the two linear axes parallel to the supporting surface, wherein the two linear axes are perpendicular to each other.

Based on the above description, in the servo tuning device and the servo tuning method of the present disclosure, by disposing the reflection component and the photoelectric sensor on the moving base and the working platform, with different loop gains applied, the moving base and the working platform are actuated to move/rotate along the two linear axes as well as the rotation axis. Accordingly, the photoelectric sensor senses the relative movement corresponding to the forward/backward path so as to calculate an ideal loop gain value used for tuning the servo setting (e.g. displacement speed) of the two linear axes or the rotation axis. Therefore, the servo of two linear axes and the servo of the rotation axis are matched.

What is claimed is:

1. A servo tuning device adapted to a multi-axis machine tool at least having two linear axes and a rotation axis, with the two linear axes and the rotation axis configured to allow a moving base and a working platform of the multi-axis machine tool to move relatively to each other, and the servo tuning device comprising:
a reflection component having a reflection surface, with the reflection component configured to be disposed on one of the moving base and the working platform;
a photoelectric sensor having a light-emitting element and a light-receiving element, with both of the light-emitting element and the light-receiving element facing the reflection surface of the reflection component, the photoelectric sensor configured to be disposed on the other one of the moving base and the working platform; and
a processor electrically connected to the photoelectric sensor, with the processor recording information of relative movement between the photoelectric sensor and the reflection surface so as to calculate a loop gain value for tuning a servo setting of the two linear axes or the rotation axis.

2. The servo tuning device according to claim 1, wherein the information of relative movement between the photoelectric sensor and the reflection surface comprises a set of tracking error values generated by a movement of a light image along a path, the light image is emitted onto the reflection surface by the photoelectric sensor, the set of tracking error values is related to a difference between a forward total relative movement and a backward total relative movement between the photoelectric sensor and the reflection surface, with said forward total relative movement formed during a period wherein the light image moves forward along the path, and with said backward total relative movement formed during another period wherein the light image moves backward along the path.

3. The servo tuning device according to claim 2, wherein the rotation axis is parallel to a supporting surface of the working platform, one of the two linear axes is parallel with the supporting surface, the other one of the two linear axes is perpendicular to the supporting surface, and both of the working platform and the moving base move along a first path serving as the path, with the first path is formed by a rotation around the rotation axis and a sum of movement vectors of the two linear axes.

4. The servo tuning device according to claim 3, wherein the reflection surface of the reflection component comprises an arc surface.

5. The servo tuning device according to claim 2, wherein the rotation axis is perpendicular to a supporting surface of the working platform, the two linear axes are parallel with the supporting surface, and both of the working platform and the moving base move along a second path serving as the path, with the second path is formed by a rotation around the rotation axis and a sum of movement vectors of the two linear axes.

6. The servo tuning device according to claim 5, wherein the reflection surface of the reflection component comprises a flat surface.

7. A servo tuning method adapted to a multi-axis machine tool at least having two linear axes and a rotation axis configured to allow a moving base and a working platform of the multi-axis machine tool to move relatively to each other, and the servo tuning method comprising:
disposing a reflection component on one of the moving base and the working platform and disposing a photoelectric sensor on the other one of the moving base and the working platform;
actuating the moving base and the working platform so that a light image, emitted by the photoelectric sensor, moves along a path on a reflection surface of the reflection component; and
calculating a loop gain value according to information of relative movement between the photoelectric sensor and the reflection surface for tuning a servo setting of the two linear axes or the rotation axis.

8. The servo tuning method according to claim 7, wherein calculating the loop gain value according to the information of relative movement between the photoelectric sensor and the reflection surface comprising:
calculating a first tracking error value related to the path corresponding to a first loop gain and a second tracking error value related to the path corresponding to a second loop gain; and
processing the first tracking error value and the second tracking error value based on a regression analysis for obtaining the loop gain value,
wherein the first tracking error value and the second tracking error value are related to a difference between a forward total relative movement and a backward total relative movement between the photoelectric sensor and the reflection surface, with said forward total relative movement formed during a period wherein the light image moves forward along the path, and with said backward total relative movement formed during another period wherein the light image moves backward along the path.

9. The servo tuning method according to claim 7, wherein actuating the moving base and the working platform comprises:
actuating the working platform to rotate around the rotation axis parallel with a supporting surface of the working platform and actuating the moving base to move in a direction of a sum of movement vectors of the two linear axes,
wherein one of the two linear axes is parallel with the supporting surface and the other one of the two linear axes is perpendicular to the supporting surface.

10. The servo tuning method according to claim 7, wherein actuating the moving base and the working platform comprises:
actuating the working platform to rotate around the rotation axis perpendicular to a supporting surface of the working platform and actuating the moving base to move in a direction of a sum of movement vectors of the two linear axes parallel the supporting surface, wherein the two linear axes are perpendicular to each other.
